(19) United States
(12) Patent Application Publication
(10) Pub. No.: US 2011/0077007 A1
(43) Pub. Date: Mar. 31, 2011

(54) WIRELESS LOCATION MEASUREMENT METHOD

(75) Inventor: Kanghee KIM, Daejeon (KR)

(73) Assignee: Electronics and Telecommunications Research Institute, Daejeon (KR)

(21) Appl. No.: 12/892,349

(22) Filed: Sep. 28, 2010

(30) Foreign Application Priority Data
Sep. 29, 2009 (KR) 10-2009-0092405
Sep. 13, 2010 (KR) 10-2010-0089626

(51) Int. Cl. H04W 24/00; H04W 36/00

(52) U.S. Cl. 455/436; 455/456.2; 455/67.11

(57) ABSTRACT

A method for a base station to search terminals broadcasts a search initiated message for notifying searching, receives a response message from a terminal having received the search initiated message, and determines whether the terminal having transmitted the response message is a search target. A method for a simplified base station installed in an event zone to perform a location measurement process with a terminal broadcasts a search initiated message for notifying searching to an event zone, and performs a location measurement process with a terminal having received the search initiated message. A method for a terminal to perform a location measurement process receives a search initiated message for notifying searching, and performs a location measurement process by using information included in the search initiated message.

### CROSS-REFERENCE TO RELATED APPLICATION

This application claims priority to and the benefit of Korean Patent Application No. 10-2009-0092405 and 10-2010-0089626 filed in the Korean Intellectual Property Office on Sep. 29, 2009 and Sep. 13, 2010, the entire contents of which are incorporated herein by reference.

### BACKGROUND OF THE INVENTION

(a) Field of the Invention

The present invention relates to a wireless location measurement method. More particularly, the present invention relates to a method for searching a terminal and measuring a location.

(b) Description of the Related Art

Wireless location measurement represents a skill for acquiring information on location, speed, or features of other things by using wireless communication. Wireless location measurement is helpful because it checks the location of a terminal to provide an appropriate treatment in an emergency case, but it may not easy to increase the accuracy of location measurement when a global positioning system (GPS) is used while the line of sight (LOS) is not given or when channel information on the area in which the emergency happened is insufficient. Also, it is first required to check if a terminal is positioned in the emergency area in order to provide an appropriate service to the terminal. Therefore, it is needed to start the location measurement process when the base station has started to search for the terminal in the emergency state instead of starting the location measurement process by MS-initiation or network-initiation.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a wireless location measurement method for a base station to search a terminal and measure a location.

An exemplary embodiment of the present invention provides a method for a base station to search a terminal, including: broadcasting a search initiated message for notifying searching; receiving a response message from a terminal having received the search initiated message; and determining whether the terminal is a search target based on the response message.

The search initiated message includes a search purpose and a search mode, and the search mode shows a response method of the terminal having received the search initiated message.

The search initiated message includes a simplified base station list installed in an event zone and performing a location measurement process.

The response message includes location measurement information of the terminal, and the location measurement information includes a location measurement processing result between the terminal and the simplified base station in the simplified base station list.

The determining includes, when the response message includes location measurement information of the terminal, determining whether the terminal is a search target in an event zone by using the location measurement information.

The determining includes, when the response message does not include location measurement information of the terminal, performing a location measurement process with the terminal, and the base station is a simplified base station installed in the event zone.

Another embodiment of the present invention provides a method for a simplified base station installed in an event zone to perform a location measurement process with a terminal, including: broadcasting a search initiated message for notifying search to the event zone; and performing a location measurement process with a terminal having received the search initiated message.

The performing includes transmitting a location measurement signal, and the method further includes receiving the location measurement processed result from the terminal.

The performing includes receiving a location measurement signal from the terminal, and calculating a location of the terminal by using the location measurement signal.

Yet another embodiment of the present invention provides a method for a terminal to perform a location measurement process, including: receiving a search initiated message for notifying searching; and performing a location measurement process by using information included in the search initiated message.

The performing includes performing a location measurement process with a simplified base station installed in an event zone, and information of the simplified base station is included in the search initiated message.

When the location measurement process is a downlink location measurement process, the method further includes transmitting a location measurement processing result to the base station.

The location measurement processing result includes location measurement information, and the location measurement information includes at least one of the location measurement result and information collected for location measurement.

The method further includes: handing over to a simplified base station installed in an event zone; and transmitting the location measurement processing result to the simplified base station.

According to an embodiment of the present invention, the base station can search a terminal that satisfies the searching purpose and can detect the location by using a search initiated message.

### BRIEF DESCRIPTION OF THE DRAWINGS

FIG. 1 shows a wireless communication system according to an exemplary embodiment of the present invention.

FIG. 2 shows a flowchart of a method for a base station to search a terminal according to an exemplary embodiment of the present invention.

FIG. 3 shows a flowchart of a method for a simplified base station to perform a location measurement process with a terminal according to an exemplary embodiment of the present invention.

FIG. 4 shows a flowchart of a method for a terminal to perform a location measurement process according to an exemplary embodiment of the present invention.

FIG. 5 shows a flowchart of a method for a terminal to perform a location measurement process according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station (MS), the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

A wireless location measurement method according to an exemplary embodiment of the present invention will now be described with reference to the accompanying drawings.

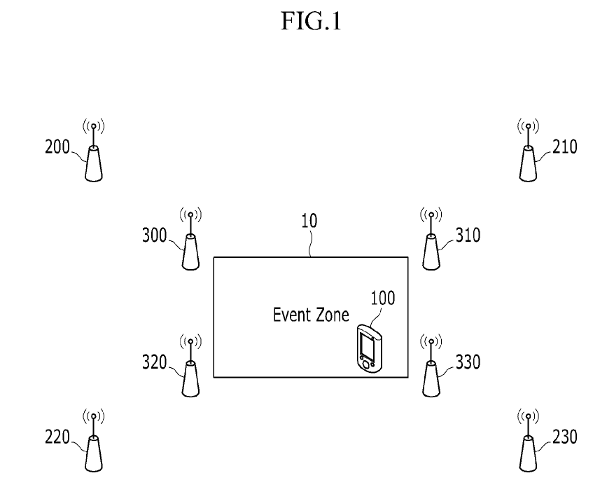

FIG. 1 shows a wireless communication system according to an exemplary embodiment of the present invention.

Referring to FIG. 1, the location of the terminal 100 can be calculated by using location measurement signals transmitted by a plurality of communication base stations (200-230), or it can be calculated by transmitting information for location measurement to another device and controlling the device to calculate the same. The location measurement process can be performed by the mobile station (MS)-initiated scheme in which the terminal 100 needing location information begins the location measurement process, and it can also be started by a process for the base stations (200-230) requiring location information of the terminal 100 to search for the terminal 100.

The base stations (200-230) for covering predetermined cells can search the terminals. However, for example, when the purpose is to search the terminal located in an event zone (10), it may be difficult to add an additional function for search terminals to the base stations (200-230). Hence, the terminal can be searched and the location measurement process can be processed through simplified base stations (300-330) by installing the simplified base station (300-330) in the event zone 10.

The simplified base stations (300-330) can support a plurality of communication methods. The simplified base stations (300-330) can broadcast a message for notifying that the terminal is searched, and can perform an uplink and downlink location measurement process by communication with the terminal 100. In addition, simplified base stations (300-330) can transmit location measurement information to a location measurement device (not shown) for calculating the location of the terminal, and can operate as wireless relays for interface with the location measurement device.

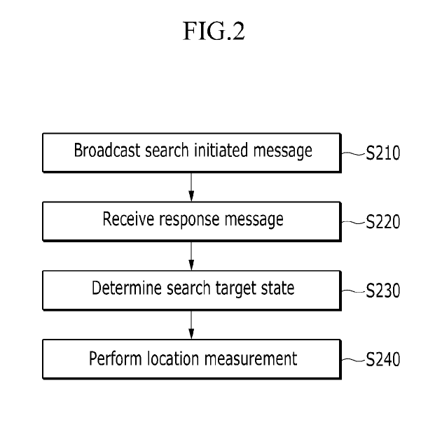

FIG. 2 shows a flowchart of a method for a base station to search a terminal according to an exemplary embodiment of the present invention.

Referring to FIG. 2, the base station broadcasts a search-initiated message (S210). The search initiated message notifies of the terminal's search, and includes search information. The search initiated message can include a search purpose and a search mode. The search purpose represents the purpose of broadcasting the search initiated message, and for example, it can indicate that the terminals in the emergency area are searched. The search mode can be set in consideration of the search purpose and the terminal's response method. For example, in the case of considering a response method, it can be set as a mode for a terminal having received the search initiated message to automatically transmit a receiving response message, a mode for a terminal owner to manually transmit a response message, or a mode for transmitting a response message including location measurement information which may be a location measurement result performed by the terminal or the information that is collected for location measurement.

The base station receives the response message from the terminal (S220). The response message can include information responded automatically or manually by the terminal, and can further include location measurement information.

The base station considers the response message to determine whether a terminal is a search target (S230) by analyzing a search initiated message broadcasting method, a broadcasting range, and a response message. For example, when the response message includes location measurement information, the base station can determine whether the terminal is a search target within the event zone by using location measurement information. In addition, when the base station has broadcast the search initiated message through a directional antenna, it can determine the terminal having responded to the search initiated message as a search target.

The base station performs a location measurement process when attempting to acquire the location of the terminal as a search target (S240). In this instance, the base station can transmit an additional message in order for the terminal as a search target to start the location measurement process. The additional message can include information for requesting to answer to location measurement information or information for requesting to transmit an uplink location measurement signal.

The method according to an exemplary embodiment described with reference to FIG. 2 can be performed by general communication base stations (200-230 of FIG. 1) or the simplified base stations (300-330 of FIG. 1) installed in the event zone. In this instance, the communication base stations (200-230) transmit the performance result to the simplified base stations (300-330). Differing from this, the communication base stations (200-230) broadcast the search initiated message, and the simplified base stations (300-330) perform the location measurement process with the terminal located in the event zone. For this, the communication base stations (200-230) can include a simplified base station list in the search initiated message and can broadcast it.

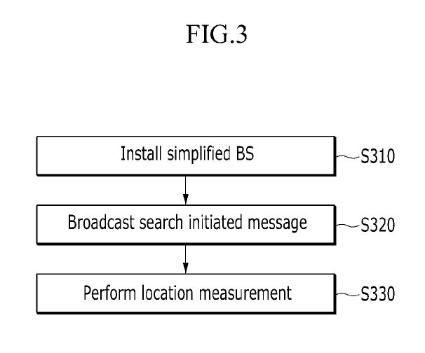

FIG. 3 shows a flowchart of a method for a simplified base station to perform a location measurement process with a terminal according to an exemplary embodiment of the present invention.

The simplified base stations (300-330 of FIG. 1) are installed in the event zone where the terminal is to be searched (S310).

The simplified base stations (300-330) broadcast the search initiated message to the event zone (S320). The simplified base stations (300-330) control the radius of the cell or broadcast the search initiated message by using the directional antenna in the event zone direction so as to search the terminal in the event zone.

The simplified base stations (300-330) perform the location measurement process with the terminal (100 of FIG. 1) having received the search initiated message (S330). The location measurement method uses one of the downlink location measurement or the uplink location measurement method. In the case of the downlink location measurement, the simplified base stations (300-330) transmit a downlink location measurement signal, and the terminal 100 receives it and performs the location measurement process. In this instance, the simplified base stations (300-330) can receive the location measurement processed result that is location measurement information from the terminal 100. In the case of uplink location measurement, the simplified base stations (300-330) receive an uplink location measurement signal from the terminal 100 to perform the location measurement process.

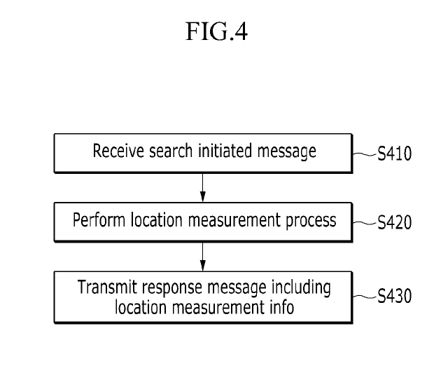

FIG. 4 shows a flowchart of a method for a terminal to perform a location measurement process according to an exemplary embodiment of the present invention.

Referring to FIG. 4, the terminal (100 of FIG. 1) receives a search initiated message (S410). The search initiated message includes information for notifying terminal searching. The terminal 100 can broadcast the search initiated message at the communication base stations (200-230 of FIG. 1) or the simplified base stations (300-330 of FIG. 1).

The terminal 100 performs the location measurement process according to the search initiated message (S420). The terminal 100 automatically transmits a response message according to the search initiated message, or manually transmits the same by determining whether it is positioned in the event zone, and it can perform the location measurement process if possible. In this instance, the terminal 100 can perform the location measurement process with the base station belonging to information that is included in the search initiated message, particularly a simplified base station list. The terminal uses the location measurement signal transmitted by the simplified base stations (300-330) to perform a downlink location measurement process or transmit the location measurement signal to the simplified base stations (300-330). In this instance, when the terminal 100 is not handed over to one of the simplified base stations (300-330), the terminal 100 performs the location measurement process through the simplified base stations (300-330), and performs other processes through the communication base station 200.

The terminal 100 includes the location measurement processing result in the response message and transmits the same (S430). The terminal 100 transmits a response message to a predetermined address that can be addresses of the simplified base stations (300-330) having performed the location measurement process or communication base stations (200-230). When the communication base stations (200-230) receive the response message, the communication base stations (200-230) can transmit the received information to one simplified base station (e.g., 300). The location measurement processing result includes location measurement information that can be a location measurement result or information collected for location measurement. In this instance, when the terminal 100 transmits an uplink location measurement signal to the simplified base stations (300-330) to perform the location measurement process, it may not transmit an additional response message.

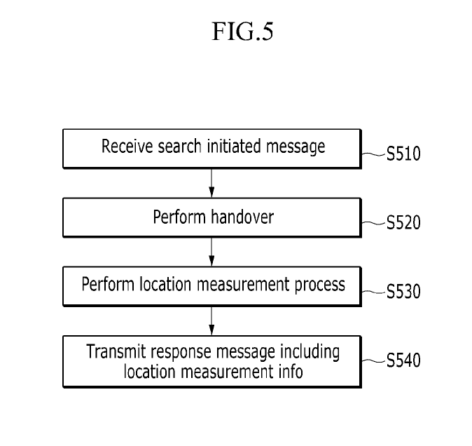

FIG. 5 shows a flowchart of a method for a terminal to perform a location measurement process according to another exemplary embodiment of the present invention.

Referring to FIG. 5, the terminal (100 of FIG. 1) receives a search initiated message (S510).

Upon receiving the search initiated message, the terminal 100 hands over to the simplified base station (e.g., 300 of FIG. 1) (S520) when the simplified base station 300 provides uplink/downlink communication in a like manner of the communication base station.

The terminal 100 performs a location measurement process with the simplified base stations (300-330) installed in the event zone (S530), and includes location measurement information in a response message and transmits it to the simplified base station 300 to which the terminal is handed over when the downlink location measurement process is performed (S540).

As described, the base station can provide an appropriate service to the searched terminal when the base station and the terminal perform the location measurement process by using the search initiated message.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a base station to search a terminal, comprising:
broadcasting a search initiated message for notifying searching;
receiving a response message from a terminal having received the search initiated message; and
determining whether the terminal is a search target based on the response message.

2. The method of claim 1, wherein
the search initiated message includes a search purpose and a search mode, and
the search mode shows a response method of the terminal having received the search initiated message.

3. The method of claim 1, wherein
the search initiated message includes a simplified base station list installed in an event zone and performing a location measurement process.

4. The method of claim 3, wherein
the response message includes location measurement information of the terminal, and
the location measurement information includes a location measurement processing result between the terminal and the simplified base station in the simplified base station list.

5. The method of claim 1, wherein
the determining includes,
when the response message includes location measurement information of the terminal, determining whether the terminal is a search target in an event zone by using the location measurement information.

6. The method of claim 1, wherein
the determining includes,
when the response message does not include location measurement information of the terminal, performing a location measurement process with the terminal.

7. The method of claim 6, wherein
the base station is a simplified base station installed in the event zone.

8. A method for a simplified base station installed in an event zone to perform a location measurement process with a terminal, comprising:
broadcasting a search initiated message for notifying search to the event zone; and
performing a location measurement process with a terminal having received the search initiated message.

9. The method of claim 8, wherein
the performing includes transmitting a location measurement signal.

10. The method of claim 9, further including
receiving the location measurement processed result from the terminal.

11. The method of claim 8, wherein
the performing includes
receiving a location measurement signal from the terminal, and
calculating a location of the terminal by using the location measurement signal.

12. A method for a terminal to perform a location measurement process, comprising:
receiving a search initiated message for notifying searching; and
performing a location measurement process by using information included in the search initiated message.

13. The method of claim 12, wherein
the performing includes performing a location measurement process with a simplified base station installed in an event zone, and
information of the simplified base station is included in the search initiated message.

14. The method of claim 12, wherein,
when the location measurement process is a downlink location measurement process,
the method further includes transmitting a location measurement processing result to the base station.

15. The method of claim 14, wherein
the location measurement processing result includes location measurement information, and
the location measurement information includes at least one of the location measurement result and information collected for location measurement.

16. The method of claim 12, further including:
handing over to a simplified base station installed in an event zone; and
transmitting the location measurement processing result to the simplified base station.
